(19) United States
(12) Patent Application Publication
(10) Pub. No.: US 2026/0067789 A1
(43) Pub. Date: Mar. 5, 2026

(54) UTILIZING USER PROFILE INFORMATION TO DYNAMICALLY DETERMINE WHETHER TO RESTRICT A USER FROM NETWORK TECHNOLOGIES

(71) Applicant: T-MOBILE INNOVATIONS LLC, Overland Park, KS (US)

(72) Inventor: Ariful Islam KAZI, Renton, WA (US)

(21) Appl. No.: 18/823,225

(22) Filed: Sep. 3, 2024

(51) Int. Cl. H04W 48/08; H04W 8/18; H04W 48/16

(52) U.S. Cl. CPC H04W 48/08; H04W 8/18; H04W 48/16

(57) ABSTRACT

Systems and methods are contemplated herein for determining whether to restrict a user's access to one or more network technologies. The method may include receiving, at a restriction module, an indication to initiate a logic flow. The method may include retrieving, by the restriction module during the logic flow, user profile information associated with the user. The method may include determining, based on the user profile information associated with the user, whether to exclude the user from restriction or restrict the user's access to the one or more network technologies.

### SUMMARY

The present disclosure is directed, in part to determining whether to restrict users from one or more network technologies, substantially as shown and/or described in connection with at least one of the figures, and as set forth more completely in the claims.

According to various aspects of the technology, various network technologies may be used by users accessing network resources (e.g., 2G, 3G, 4G, LTE, 5G). Early-generation technologies, such as 2G and 3G, are being decommissioned at increasing rates as newer technologies take hold. A mobile network operator (MNO) may wish to selectively restrict the user of various network technologies in phases, targeting different groups of users at a time. Thus, methods enabling such selective restriction of users to network technologies provide flexibility in MNO decommissioning of earlier technologies. While conventional systems enable a phased approach, they lack flexibility and the ability for MNOs to modify the system. Systems and methods of restricting users from accessing one or more network technologies are contemplated herein that enable a restriction module to selectively restrict users from using the one or more network technologies based on user profile information.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary logic flow for determining whether to exclude a user from restriction or to restrict the user from one or more network technologies in which implementations of the present disclosure may be employed; and

FIG. 4 illustrates a flow diagram of an exemplary method for determining whether to exclude a user from restriction or to restrict the user from one or more network technologies in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, various network technologies may be used by users accessing network resources, such as 2G, 3G, 4G, LTE, 5G, and the like. Early-generation technologies, such as 2G and 3G, are being decommissioned at increasing rates as newer technologies take hold, such as 4G and 5G. However, abrupt termination of earlier technologies may cause major disruptions to areas that rely on these earlier network technologies (e.g., rural areas, high-density areas, underground areas). A mobile network operator (MNO) may wish to selectively restrict the user of various network technologies in phases, targeting different groups of users at a time. Thus, methods enabling such selective restriction of users to network technologies provide flexibility in MNO decommissioning of earlier technologies are desirable.

Conventionally, MNOs often decommission services and/or technologies using a phased approach, however, these phased approaches typically only consider one variable. For example, a MNO may elect to decommission a particular service and/or technology area by area, where some areas are restricted from the service and/or technology prior to other areas. While these types of systems enable a phased approach, they lack flexibility and robustness. For example, an MNO may wish to restrict users based on which MNO the user is subscribed to, the type of device the user has, whether the user is active, and more. Present systems and methods are insufficient to make robust determinations and provide this improved flexibility.

In contrast to conventional solutions and to provide a flexible and robust approach to decommissioning one or more network technologies, the present disclosure is directed to systems and methods of restricting users from accessing one or more network technologies. A network may incorporate a restriction module to selectively restrict particular users from using the one or more network technologies. The restriction module may retrieve user profile information, such as MNO information (e.g., what MNO the user is subscribed to), device information (e.g., what manufacturer and make of device), restriction information (e.g., a restriction indicator), and/or roaming subscriber information (RSI). The restriction module may perform a logic flow using at least some of the user profile information. For example, restriction module may retrieve MNO information and determine that users associated with a particular MNO are excluded from restriction at that time. The restriction module may determine, after considering at least some of the user profile information, to restrict a user from the one or more network technologies. The restriction module may effectuate the restriction by modifying the RSI of the user to indicate the user cannot access the one or more network technologies. This solution provides a more robust and flexible phased approach to restricting users from one or more network technologies and/or decommissioning the one or more network technologies.

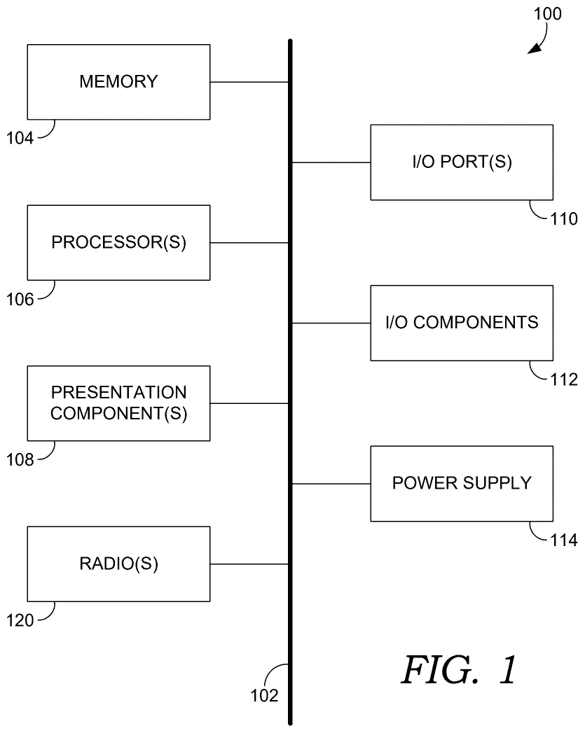

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VOIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

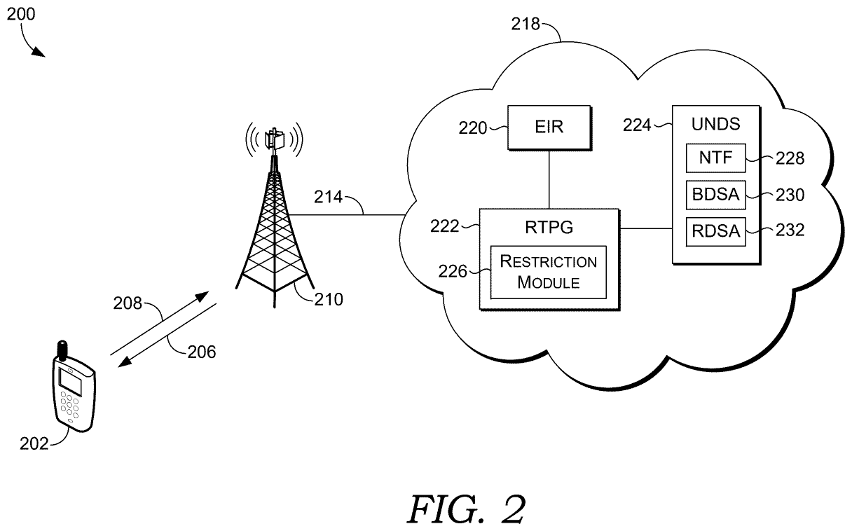

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a UE 202, one or more base stations, such as a base station 210, and a core network 218, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the UE 202 to data or services that may be accessible on one or more application servers or other functions, nodes, or servers not pictured in FIG. 2 so as to not obscure the focus on the present disclosure.

The network environment 200 comprises the UE 202. The UE 202 is illustrated generally, and may take any number of forms, including a tablet, phone, or wearable device, or any other device discussed with respect to FIG. 1 and may have any one or more components or features of the computing device 100 of FIG. 1. In aspects, the UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the base station 210 to which the UE 202 may potentially connect to (also referred to as ‘camping on,’ ‘attaching,’ in the industry). Though network environment 200 is illustrated with one base station 210, one skilled in the art will appreciate that more or fewer base stations may be present in any particular network environment. The base station 210 of the network environment 200 is configured to wirelessly communicate with UEs, such as the UE 202. In aspects, the base station 210 may communicate with the UE 202 using any wireless telecommunication protocol desired by a network operator, including but not limited to 2G, 3G, 4G, 5G, 6G, 802.11x and the like.

The base station 210 is configured to communicate with one or more UEs, such as the UE 202. The base station 210 may communicate signals to one or more UEs via a downlink 206 and receive signals from one or more UEs via uplink 208. In response to receiving certain requests to and/or from the UE 202, the base station 210 may communicate with the core network 218 via a backhaul 214. For example, in order for the UE 202 to connect to a desired network service (e.g., PSTN call, voice over LTE (VoLTE) call, voice over new radio (VoNR), data, or the like), the UE 202 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. NFs within the core network 218 are defined by their function, as the core network 218 is a service-based architecture. The core network 218 may comprise NFs that include any one or more of an equipment identity register (EIR) 220, a real-time provisioning gateway (RTPG) 222, and a unified network directory server (UNDS) 224. Each of these NFs may communicate with each other, directly or indirectly, via interfaces existing between them. Each of the preceding NFs may take different forms, including consolidated or distributed forms that perform the same general operations. In other architectures or protocols, the NFs may be given other names, however, the NFs herein refer to functions, not specifically identified components. For example, the EIR 220 may instead be a different device management platform.

Though the EIR 220, the RTPG 222, and the UNDS 224 are illustrated in the core network 218, the core network 218 may have more or fewer NFs than shown. For example, the core network 218 may include a provisioning gateway (PGW), and in some aspects, the PGW may be another component of the UNDS 224. Further, though EIR 220, the RTPG 222, and the UNDS 224 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The EIR 220, for example, is generally responsible for managing device information (e.g., international mobile equipment identities (IMEIs)) which allows the network to allow, monitor, or block devices attempting to access the network. The EIR 220 may communicate with the UNDS 224, such as to update device information stored at the UNDS 224 (e.g., the EIR 220 communicates the UE 202 is blocked from accessing the network, and the UNDS 224 stores this determination in one or more of its directories).

The RTPG 222, for example, is generally responsible for facilitating the activation, deactivation, and management of services for users of the network, ensuring that service changes are processed and applied in real-time. The RTPG 222 may comprise a restriction module 226. The restriction module 226 is generally responsible for restricting users or excluding users from restriction based on at least some user profile information.

The UNDS 224, for example, is generally responsible for centralizing and consolidating user and network data across multiple systems in the one or more directories of the UNDS 224, providing a single source of information for efficient network management. The UNDS 224 may comprise a network trigger function (NTF) 228, a backend directory server agent (BDSA) 230 (i.e., the one or more directories of the UNDS 224), and a routing directory server agent (RDSA) 232. While each of the NTF 228, the BDSA 230, and the RDSA 232 are shown in the singular, it is expressly contemplated that there may be more than one of each of the NTF 228, the BDSA 230, and the RDSA 232. The NTF 228 may, for example, generally be responsible for causing the restriction module 226 to initiate a logic flow. The BDSA 230 may, for example, store the user profile information relevant to the restriction module 226. The RDSA 232 may, for example, direct various NFs to particular user profile information stored by the BDSA 230.

Relevant to the present disclosure, the restriction module 226 may be configured to perform a logic flow. During the logic flow, the restriction module 226 may retrieve various user profile information from one or more network components (e.g., the RTPG 222, the restriction module 226, and/or the UNDS 224). Based on at least some of the user profile information, the restriction module 226 determines whether a particular user (e.g., a user associated with the UE 202) is eligible for restriction from one or more network technologies (e.g., 2G and 3G) or whether the user is excluded from restriction. If the restriction module 226 determines the user is eligible for restriction from one or more network technologies, the restriction module 226 may modify the RSI of the user to effectuate the restriction of the user's access to the one or more network technologies.

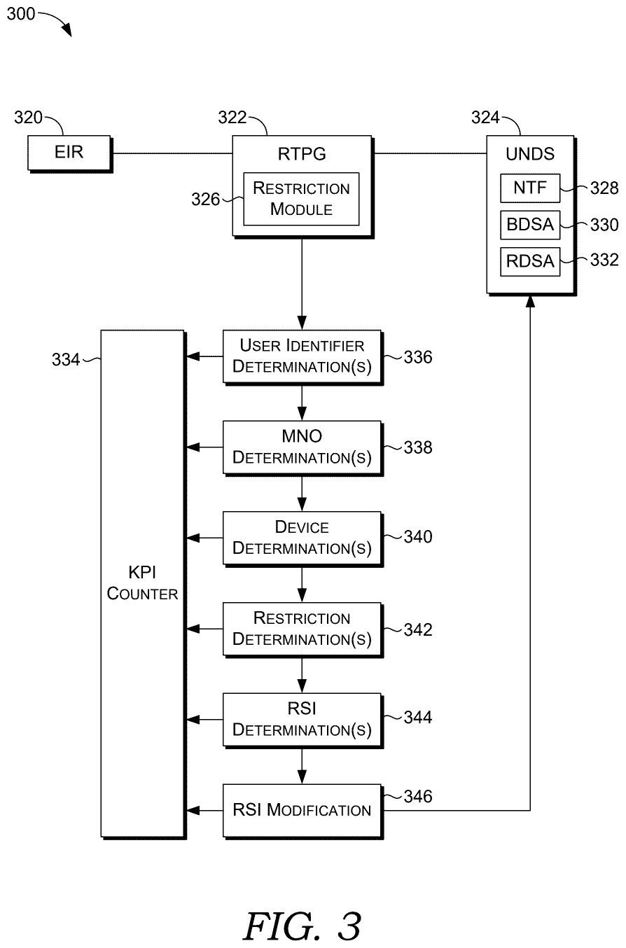

Turning now to FIG. 3, a logic flow diagram is illustrated in accordance with one or more aspects of the present disclosure. A logic flow 300 may be performed by and/or facilitated by one or more NFs discussed in greater detail herein and is not meant to exhaustively show every interaction that would be necessary to practice the invention, so as not to obscure the present disclosure. The logic flow 300 may generally involve an EIR 320 (e.g., the EIR 220 of FIG. 2), an RTPG 322 (e.g., the RTPG 222 of FIG. 2), a UNDS 324 (e.g., the UNDS 224 of FIG. 2), and a key performance indicator (KPI) counter 334. The RTPG 322 may include a restriction module 326 (e.g., the restriction module 226 of FIG. 2). The UNDS 324 may include an NTF 328 (e.g., the NTF 228 of FIG. 2), a BDSA 330 (e.g., the BDSA 230 of FIG. 2), and an RDSA 232 (e.g., the RDSA 232 of FIG. 2). Each of the preceding NFs may take different forms, including consolidated or distributed forms that perform the same general operations. In other architectures or protocols, the NFs may be given other names, however, the NFs herein refer to functions, not specifically identified components.

The logic flow 300 includes the KPI counter 334, which is generally responsible for collecting, storing, organizing, and/or allocating KPIs associated with the logic flow 300. For example, if a user is found to be excluded from restriction, the occurrence of this determination may be communicated to the KPI counter 334 by the restriction module 326. Further, for example, if the user is found to be eligible for restriction of the one or more network technologies, the occurrence of this determination may similarly be communicated to the KPI counter 334. In aspects, the KPI counter 334 is a subcomponent and/or a module of one of the EIR 320, the RTPG 322, or the UNDS 326. In some aspects, the KPI counter 334 collects, stores, and organizes the determinations in the KPI counter 334, and in other aspects, the KPI counter 334 collects, organizes, and allocates the determination to other network components or other NFs (e.g., a performance management system (PMS), a network management system (NMS)). The KPI counter 334 may additionally collect, store, organize, and/or allocate data associated with the determination, such as the information relevant to the determination (e.g., the user identifier information, the MNO information, the device information, the restriction determination, and/or the RSI associated with the user) and which information was dispositive in making the determination. The KPI counter 334 may collect metadata such as time of determination, network access type of the user, and the like.

In aspects, the logic flow 300 may be initiated by the RTPG 322 and/or the restriction module 326 receiving an indication to initiate the logic flow 300. The restriction module 326 may be configured to initiate the logic flow 300 upon receipt of the indication. In some aspects, the indication is received by the RTPG 322 and/or the restriction module 326 from one of the UNDS 324 or the EIR 320. The EIR 320 may be configured to identify particular device changes associated with the user, and in response, notify the RTPG 320 and/or the restriction module 326 of the device changes (e.g., in the indication to initiate the logic flow 300). The NTF 328 of the UNDS 324 may be configured to identify particular provisioning changes associated with the user, and in response, notify the RTPG 320 and/or the restriction module 326 of the provisioning changes (e.g., in the indication to initiate the logic flow 300). In other aspects, the indication to initiate the logic flow 300 may be communicated by only the UNDS 324. In such aspects, the EIR 320 may communicate with the UNDS 324 and update one or more user profile information databases of the UNDS 324 (e.g., the BDSA 330) of one or more device changes associated with the user. In such aspects, the NTF 328 of the UNDS 324 may be configured to identify specified provisioning and device changes associated with the user and/or the device associated with the user, and in response, notify the RTPG 322 and/or the restriction module 326 of the provisioning and/or device changes (e.g., in real-time), causing the logic flow 300 to initiate. In other aspects, the logic flow 300 is manually initiated, such as by an MNO.

Provisioning changes and device changes associated with the user may take a number of possible forms. Provisioning changes generally include changes to plans the user is subscribed to, changes to the subscriber identity module (SIM) card, mobile station international subscriber directory number (MSISDN) changes, service activation, service deactivation, service reactivation, and the like. For example, a user may elect to increase their QoS of their subscription plan, add additional services to their subscription plan (e.g., purchase additional data resources, purchase additional minutes), bundle various services together, extend the duration of their subscription plan, and the like. The user may change their MSISDN, activate a new subscription plan, activate a new subscriber identity module (SIM) card, and the like. Device changes may be associated with a device associated with the user. Device changes may include a device's registration with the network (e.g., the EIR 320 receives an attach request from a device associated with the user), receiving a new or unrecognized device identifier (e.g., an international mobile equipment identity (IMEI)) (e.g., at UNDS 324, at the EIR 320), identifying a roaming device using the network, and the like.

Once the logic flow 300 is initiated, the restriction module 326 may retrieve user profile information associated with a user. User profile information may include any one or more of user identifier information, MNO information, device information, restriction information, and roaming subscriber information (RSI). In some aspects, the restriction module 326 retrieves the user profile information before making any determinations based on the user profile information. In other aspects, the restriction module 326 retrieves user profile information sequentially. For example, the restriction module 326 may first retrieve the user identifier information and make one or more user identifier determinations 336 prior to retrieving additional user profile information. Advantageously, if a user is excluded from restriction at an initial determination, it may be an inefficient use of network resources to preemptively retrieve additional user profile data. In aspects, the RDSA 332 of the UNDS 324 may assist the restriction module 326 in accessing at least some of the user profile information, such as by directing the restriction module 326 to a particular database or a particular area of one or more databases, such as to one or more BDSAs (e.g., the BDSA 330) of the UNDS 324.

The restriction module 326 may retrieve user identifier information associated with the user. User identifier information may include any one or more of an MSISDN, an international mobile equipment identity (IMSI), an IMEI, an IP address, globally unique permanent identifier (GUPI), subscription permanent identifier (SUPI), and the like. In some aspects, the restriction module 326 retrieves the user identifier information from the indication causing the logic flow 300 to initiate. For example, the restriction module 326 may receive a notification and/or communication (i.e., the indication) from the RTPG and/or the UNDS 324 (e.g., the NTF 328 of the UNDS 324). In some aspects, at least some of the user identifier information is retrieved from the indication. In other aspects, the restriction module 326 retrieves the user identifier information from the UNDS 324. In such aspects, the RDSA 332 may direct the restriction module 326 to one or more areas of the UNDS 324, such as to one or more BDSAs (e.g., the BDSA 332).

The restriction module 326 may make one or more user identifier determinations 336 based on the user identifier information. In some aspects, the restriction module 326 may use the user identifier information to retrieve one or more user activity statuses from the UNDS 324. In other aspects, the restriction module 326 may retrieve the one or more activity statuses from another NF, such as a home subscriber server (HSS), a unified data management (UDM) function, and the like. As used herein, user activity statuses include subscription statuses (e.g., the user does not have an active subscription), billing statuses (e.g., the user has not paid their bill and thus cannot access the network), deactivation statuses (e.g., the user has not used the network for a specified duration), SIM card statuses (e.g., the user's SIM card is deactivated), and the like. In such aspects, the restriction module 326 may determine, based on the user identifier information, that the user associated with the user identifier information is inactive. For example, the restriction module 326 may retrieve the MSISDN associated with the user and determine the user associated with the subscription associated with the MSISDN is inactive (e.g., based on the one or more user activity statuses). When the user is determined as inactive, the restriction module 326 may determine the user is excluded from restriction and logs the occurrence of the one or more user identifier determinations 336 at the KPI counter 334. When the user is determined as active, the user is determined as eligible for restriction, and the logic flow 300 continues.

The restriction module 326 may retrieve MNO information associated with the user. In aspects, the restriction module 326 retrieves the MNO information from the UNDS 324. In such aspects, the RDSA 332 may direct the restriction module 326 to one or more areas of the UNDS 324, such as to one or more BDSAs (e.g., the BDSA 332). MNOs may engage in network sharing agreements and provide access to their infrastructure enabling MNOs without their own network infrastructure to utilize their resources. For example, MNO 1 may to allow MNO 2's users to access MNO 1's network. In this example, MNO 1 may wish to restrict MNO 2's users from accessing the one or more network technologies before its own users.

The MNO information may include a particular MNO the user is associated with (e.g., MNO 1, MNO 2). In aspects, the restriction module 326 retrieves a public land mobile network (PLMN) identifier and/or an IMSI (which may have been retrieved with the user identifier information) associated with the user. Each of the PLMN and the IMSI include a mobile country code (MCC) and a mobile network code (MNC), allowing the network to determine the particular MNO the user is associated with.

The MNO information may include the MNO's restriction exclusion status. One or more network components (e.g., the RTPG 322, the UNDS 324) may store MNO restriction exclusion statuses for each MNO that utilizes the network's resources. For example, MNOs 1-6 may have access to MNO 1's network, and MNO 1 may wish to exclude its own users from restriction, opting to target MNO 2-3's users first. In this example, MNO 1 would be excluded from restriction, which is reflected in MNO 1's restriction exclusion status. The restriction exclusion status may take various forms. For example, the presence of a restriction exclusion status may indicate the MNO is excluded from restriction, and the absence of a restriction exclusion status may indicate the MNO is eligible for restriction. In another example, the alphabetical and/or numerical value of the restriction exclusion status may indicate the MNO is excluded from restriction or that the MNO is eligible for restriction.

The restriction module 326 may make one or more MNO determinations 338 based on the MNO information. The restriction module 326 may consider which MNO the user is associated with as well as the particular MNO's restriction exclusion status. In aspects, the restriction module 326 may retrieve the MNO's restriction exclusion status once the restriction module 326 determines which MNO the user is associated with. In aspects, the restriction module 326 may determine the user is excluded from restriction based on the user's MNO having a restriction exclusion status reflecting the MNO is excluded from restriction. Based on this consideration, the restriction module 326 may determine the user associated with the particular MNO is excluded from restriction. In such aspects, the user may be excluded from restriction and the occurrence of the MNO determination logged in the KPI counter 334. In other aspects, the user may be eligible for restriction (e.g., based on the user's MNO being eligible for restriction), and thus may continue in the logic flow 300.

The restriction module 326 may retrieve device information associated with the user. The device information may include the manufacturer, make, and/or model of a device associated with the user. In aspects, the device information may comprise and/or be retrieved from an IMEI (e.g., from the user identifier information) associated with the device. The IMEI may include a type allocation code (TAC) indicating the device's manufacturer and model and a serial number that uniquely identifies the device. The device information may include the capabilities of the device associated with the user, such as what network technologies are supported by the device (e.g., 2G, 3G, 4G, 5G). In some aspects, the restriction module 326 determines the device capabilities based on the manufacturer, make, and/or model of the device, and in other aspects, the capabilities of the device are retrieved from one or more network components (e.g., the RTPG 322, and UNDS 324). In such aspects, the RDSA 332 may direct the restriction module 326 to one or more areas of the UNDS 324, such as to one or more BDSAs (e.g., the BDSA 332).

The restriction module 326 may make one or more device determinations 340 based on the device information. The restriction module 326 may consider the capabilities of the device associated with the user. For example, where the capabilities of the device are only associated with technologies that are not the target of restriction (e.g., 4G and 5G where 2G and 3G are targeted), the restriction module 326 may determine to exclude the user from restriction and log the determination in the KPI counter 334. In another example, where the capabilities of the device are only associated with technologies that are the target of restriction, the restriction module 326 may determine the user is eligible for restriction and continue the logic flow 300. In yet another example, where the capabilities of the device are associated with both targeted and non-targeted network technologies, the restriction module 326 may determine to exclude the user from restriction and log the determination in the KPI counter 334 or determine the user is eligible for restriction and continue the logic flow 300.

The restriction module 326 may retrieve restriction information associated with the user. Restriction information may include a restriction indicator. The user profile stored within the UNDS 334 may include the restriction indicator and/or be modified to include the restriction indicator. One or more NFs and/or entities (e.g., the RTPG 322, the UNDS 324, the MNO that owns and operates the network) may add the restriction indicator to the user profile including the user profile information. The restriction indicator may determine whether the restriction indicator should indicate the user is eligible for restriction or excluded from restriction. In some aspects, the restriction indicator is added ad hoc, and in other aspects, the restriction indicator is added during the logic flow 300.

The one or more NFs and/or entities may determine to add the restriction indicator and/or determine the value of based on one or more considerations. The presence and/or value of the restriction indicator may be based SIM card attributes (e.g., roaming capabilities and/or preferences, compatible services, access point name (APN) settings). For example, the MNO may determine it wishes to restrict those users with fewer roaming capabilities (e.g., relative to other users) from restriction and instead target users with basic subscription plans. The presence and/or value of the restriction indicator may be based on an activation date associated with the user activating their MNO subscription and/or SIM card. For example, the MNO may wish to exclude long-time users (i.e., users associated with earlier activation dates) (e.g., relative to other users) from restriction and instead target newer users (i.e., users associated with later activation date) (e.g., relative to other users). The presence and/or value of the restriction indicator may be based on a subscribed quality of service (QoS). For example, the MNO may determine it wishes to exclude users subscribed to high QoS requirements (e.g., relative to other users) from restriction and instead target users with lower QoS requirements.

The restriction module 326 may make one or more restriction determinations 342 based on the restriction information. In some aspects, the restriction module 326 may consider the presence of the restriction indicator. For example, the restriction indicator may be present in the user profile when the user is eligible to be restricted and absent from the user profile when the user is excluded from restriction. In other aspects, the restriction module 326 may consider the value of the restriction indicator. For example, the restriction indicator may have one value when the user is eligible to be restricted and another value when the user is excluded from restriction. When the user is determined as excluded from restriction, the determination is communicated to the KPI counter 334. When the user is determined as eligible for restriction, the logic flow 300 continues.

The restriction module 326 may retrieve RSI associated with the user. The restriction module 326 may retrieve the RSI from the user profile stored within the UNDS 324. In such aspects, the RDSA 332 may direct the restriction module 326 to one or more areas of the UNDS 324, such as to one or more BDSAs (e.g., the BDSA 332). The RSI may include one or more restrictions (i.e., access restriction entries within the RSI). For example, the user may already be excluded from one or more network technologies (e.g., 2G, 3G), or the user may subject to service restrictions, billing restrictions, usage restrictions, and the like. In some aspects, the RSI of the user may be inaccessible or otherwise unavailable.

The restriction module 326 may make one or more RSI determinations 344 based on the RSI information. In some aspects, the one or more RSI determinations include determining whether the user's RSI is present and/or accessible in the user profile. For example, where the RSI is corrupted, inaccessible, and/or otherwise unavailable to the restriction module 326, the user may be determined as excluded from restriction and the occurrence of this determination is logged with the KPI counter 334. In another example, where the RSI is present and accessible, the user may be determined as eligible for restriction. When the user is determined as excluded from restriction, the determination may be logged with the KPI counter 334. When the user is determined as eligible for restriction, the logic flow 300 continues.

The restriction module 326 may make an RSI modification 346. The restriction module 326 may modify the RSI associated with users eligible for restriction, based on one or more of the logic flow determinations described herein. The RSI may be modified to generate a modified RSI. The modified RSI may take the form of the original RSI but modified to specify the one or more network technologies being restricted. In some aspects, the modified RSI may replace the RSI within the user profile, and in other aspects, the modified RSI may be added to the user profile without replacing the original RSI. The modified RSI may effectuate a restriction to the one or more network technologies. The modified RSI indicates a user is restricted from the one or more network technologies. When the user attempts to access the one or more network technologies, one or more NFs (e.g., an access and mobility management function (AMF), a UDM, an HHS, a policy control function (PCF)) may refuse to allow access to the one or more network technologies based on the modified RSI. In aspects, the occurrence of modifying the RSI to generate the modified RSI may be logged with the KPI counter 334.

While the above determinations described with respect to FIG. 3 are described in a specific sequence, the one or more determinations may be completed in a different order than described. As one illustrative example, the restriction module 326 may make the one or more MNO determinations 338 prior to the one or more user identifier determinations 336. The criteria and/or considerations evaluated by the restriction module to make the one or more determinations may be altered, such as by the MNO that owns and operates the network. For example, in one iteration of the logic flow 300, the MNO wishes to exclude users of MNO 3, however, this may be modified such that in another iteration of the logic flow 300, the MNO wishes to allow users of MNO 3 be eligible for restriction.

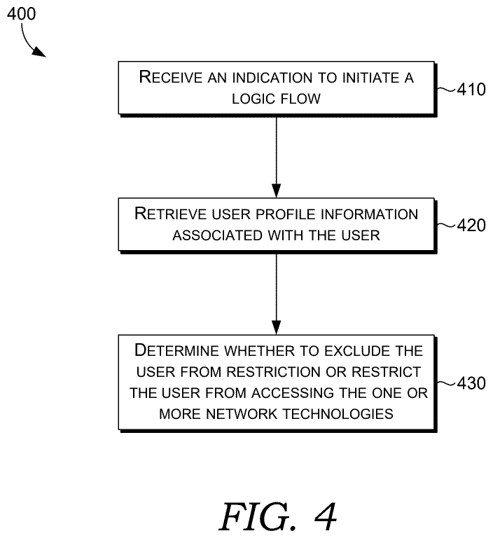

Turning now to FIG. 4, a flow chart is provided that illustrates one or more aspects of the present disclosure relating to a method 400 determining whether to restrict a user's access to one or more network technologies. The method 400 may include one or more aspects described with respect to FIGS. 2-3.

At a first step 410, a restriction module (e.g., the restriction module 226 of FIG. 2, the restriction module 326 of FIG. 3) may receive an indication to initiate the logic flow (e.g., the logic flow 300 of FIG. 3). In aspects, the indication is based on one or more of device changes and/or provisioning changes associated with the user, as described with respect to FIG. 3. At a second step 420, the restriction module retrieves user profile information associated with the user. In aspects, the restriction module retrieves the user profile information during the logic flow. The user profile information may include any one or more of user identifier information, MNO information, device information, restriction information, and/or RSI associated with the user, as described with respect to FIG. 3. In aspects, during the logic flow, the restriction module may make one or more determinations (e.g., the one or more user identifier determinations 336, the one or more MNO determinations 338, the one or more device determinations 340, the one or more restriction determinations 342, and/or the one or more RSI determinations 344 of FIG. 3), as described with respect to FIG. 3.

At a third step 430, the restriction module determines whether to exclude the user from restriction or determines to restrict the user from accessing the one or more network technologies. The restriction module may determine the user is excluded from restriction and log the relevant determination with the KPI counter (e.g., the KPI counter 334 of FIG. 3), as described with respect to FIG. 3. The restriction module may determine the user is eligible for restriction and/or determines to restrict the user from accessing the one or more network technologies. The restriction module may restrict the user by modifying the RSI associated with the user to create a modified RSI. The modified RSI may comprise a restriction of the one or more network technologies prevent the user from accessing the one or more network technologies, as described with respect to FIG. 3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for restricting a user's access of one or more network technologies, the method comprising:
receiving, at a restriction module, an indication to initiate a logic flow;
retrieving, by the restriction module during the logic flow, mobile network operator (MNO) information, device information, restriction information, and roaming subscription information (RSI), associated with the user;
based on the MNO information, the device information, the restriction information, and the RSI, associated with the user, determining to modify the RSI associated with the user.

2. The method of claim 1, further comprising modifying the RSI associated with the user to create a modified RSI, wherein the modified RSI comprises a restriction of one or more network technologies, and wherein the restriction prevents the user from accessing the one or more network technologies.

3. The method of claim 2, wherein the restriction is of 2G and 3G network technologies.

4. The method of claim 1, further comprising modifying the RSI associated with the user to create a modified RSI, wherein the modified RSI specifies a decreased quality of service for sessions using the one or more network technologies.

5. The method of claim 4, wherein the one or more network technologies are 2G and 3G network technologies.

6. The method of claim 1, wherein the indication indicates one of a device change or a provisioning change associated with the user.

7. The method of claim 1, wherein the MNO information comprises an identity of an MNO associated with the user and a restriction exclusion status of the MNO associated with the user.

8. The method of claim 1, wherein the device information comprises a type allocation code (TAC) associated with a device associated with the user.

9. The method of claim 1, wherein the restriction information comprises a restriction indicator associated with the user.

10. The method of claim 2, wherein an occurrence of modifying the RSI to create the modified RSI is logged in a key performance indicator (KPI) counter.

11. A method for determining whether to restrict a user's access of one or more network technologies, the method comprising:
receiving, at a restriction module, an indication to initiate a logic flow;
retrieving, by the restriction module during the logic flow, user profile information associated with the user;
based on the user profile information associated with the user, determining the user is excluded from restriction; and
logging the determination that the user is excluded from restriction in a key performance indicator (KPI) counter.

12. The method of claim 9, wherein the user profile information includes one or more of mobile network operator (MNO) information, device information, restriction information, and roaming subscriber information (RSI).

13. The method of claim 11, wherein the indication indicates one of a device change or a provisioning change associated with the user.

14. The method of claim 12, wherein the MNO information comprises an identity of an MNO associated with the user and a restriction exclusion status of the MNO associated with the user.

15. The method of claim 13, wherein the device information comprises a type allocation code (TAC) associated with a device of the user.

16. The method of claim 14, wherein the restriction information comprises a user restriction identifier associated with the user.

17. A method for determining whether to restrict a user's access to one or more network technologies, the method comprising:
receiving, at a restriction module, an indication to initiate a logic flow;
retrieving, by the restriction module during the logic flow, user profile information associated with the user; and
based on the user profile information associated with the user, determining whether to exclude the user from restriction or restrict the user's access to the one or more network technologies.

18. The method of claim 17, further comprising:
determining to exclude the user from restriction based on the user profile information indicating the user is excluded from restriction, wherein the user profile information includes one or more of MNO information, device information, restriction information, and roaming subscriber information (RSI); and
refraining from modifying the RSI associated with the user; and
logging the determination to exclude the user from restriction in a key performance indicator (KPI) counter.

19. The method of claim 17, further comprising:
determining to restrict the user's access to the one or more network technologies based on the user profile information indicating the user should be restricted, wherein the user profile information includes MNO information, device information, restriction information, and roaming subscriber information (RSI); and
modifying the RSI associated with the user to create a modified RSI, wherein the modified RSI comprises a restriction of one or more network technologies, and wherein the restriction prevents the user from accessing the one or more network technologies; and
logging the determination to restrict the user's access in a key performance indicator (KPI) counter.

20. The method of claim 19, further comprising adding the modified RSI to a user profile associated with the user.
